(19) United States
(12) Patent Application Publication
(10) Pub. No.: US 2025/0053453 A1
(43) Pub. Date: Feb. 13, 2025

(54) SYSTEM AND METHOD FOR IMPLEMENTING AN ADVISORY ASSISTANT TO A GENERATIVE ARTIFICAL INTELLIGENCE TOOL

(71) Applicant: KPMG LLP, New York, NY (US)

(72) Inventors: Joshua McClung, Herdon, VA (US); Ryan Atkins, Reston, VA (US); Mohammad Mirwais Bilal, Fairfax, VA (US); Bryan Hardy, Logandale, NV (US); David Keller, Littleton, CO (US)

(21) Appl. No.: 18/798,221

(22) Filed: Aug. 8, 2024

Related U.S. Application Data
(60) Provisional application No. 63/531,388, filed on Aug. 8, 2023.

(51) Int. Cl. G06F 9/50; G06N 5/022

(52) U.S. Cl. CPC G06F 9/5027; G06N 5/022

(57) ABSTRACT

The invention relates to computer-implemented systems and methods that implement an innovative generative AI service based on proprietary expertise and industry knowledge. The generative AI service provides unique autonomous features, such as combining separate and distinct LLM responses and prompts to create unique results. Other autonomous features may include an ability to handle scaling and auto deployment of models and rerouting requests autonomously to ensure user load is balanced across the entire globally distributed Generative AI infrastructure estate. The generative AI service may further deploy new Production instances of models on demand by predefined system criteria as well as by explicit user request based on projected demand increase and/or the need for specific instance for further model fine-tuning.

### CROSS-REFERENCE TO RELATED APPLICATIONS

The application claims priority to U.S. Provisional Application 63/531,388 (Attorney Docket No. 055089.0000113), filed Aug. 8, 2023, the contents of which are incorporated by reference herein in their entirety.

### FIELD OF THE INVENTION

The present invention relates to systems and methods for implementing a middleware platform that provides a series of generative artificial intelligence (Gen AI) services, including an advisory assistant to a generative artificial intelligence tool, and combines responses from multiple language models with proprietary data for enhanced results and outputs.

### BACKGROUND

ChatGPT (Chat Generative Pre-trained Transformer) is a state-of-the-art language model developed by OpenAI using advanced machine learning algorithms to generate human-like text based on input it receives.

Microsoft Azure OpenAI Service provides REST API access to OpenAI's language models including the GPT-4, GPT-3, Codex and Embeddings model series. It represents an opportunity for organizations looking to improve efficiency, reduce costs, and enhance customer satisfaction. By leveraging artificial intelligence technology, language processing tools enable organizations to automate a wide range of tasks that previously required human intervention.

In particular, language processing tools can assist organizations to improve customer service and support. With the ability to process and understand natural language inputs, language processing tools can provide quick and accurate responses to customer inquiries, reducing response times and increasing customer satisfaction.

In addition to customer service, language processing tools can be used for a variety of other tasks, including content creation, data analysis, business process automation, etc. For example, language processing tools can help organizations complete these tasks more efficiently and accurately, freeing up valuable time and resources for other strategic initiatives.

As technology advances, new language models are introduced and current ones continue to improve. Businesses are required to effectively leverage technology in a consistent and efficient manner to gain a significant competitive advantage while protecting proprietary and sensitive data. Current systems are unable to support new language models and the speed at which they are introduced to the market. At best, current solutions onboard one language model at a time. This leads to missed opportunities and an inability to leverage the newest features and updated technologies in a timely and efficient manner.

It would be desirable, therefore, to have a system and method that could overcome the foregoing disadvantages of known systems.

### SUMMARY

According to one embodiment, the invention relates to a computer-implemented system for implementing a middleware platform that provides a series of generative AI services. The system comprises: a user interface that is configured to receive one or more requests from a user, via a communication network; a Digital Matrix Application Gateway that is configured to receive the one or more requests and route the one or more requests to a set of API Compute Resources, wherein the set of API Compute Resources comprises one or more API Apps and one or more API App Functions, wherein each of the set of API Compute Resources is configured to make calls to one of a plurality of APIs, wherein the set of API Compute Resources interacts with a plurality of different large language models (LLMs) that collectively generate a response to the one or more requests; a data storage component that reads and writes configuration and operational data associated with the API Compute Resources; an insights analytics processing component that is configured to receive application telemetry data from one or more API Compute Resources; and a log analytics component that stores log data from the insights component.

According to another embodiment, the invention relates to a computer-implemented method for implementing a middleware platform that provides a series of generative AI services. The method comprises the steps of: receiving, via a user interface, one or more requests from a user, via a communication network; receiving, via a Digital Matrix Application Gateway, the one or more requests and routing the one or more requests to a set of API Compute Resources, wherein the set of API Compute Resources comprises one or more API Apps and one or more API App Functions, wherein each of the set of API Compute Resources is configured to make calls to one of a plurality of APIs, wherein the set of API Compute Resources interacts with a plurality of different large language models (LLMs) that collectively generate a response to the one or more requests; reading and writing, via a data storage component, configuration and operational data associated with the API Compute Resources; receiving, via an insights analytics processing component, application telemetry data from one or more API Compute Resources; storing, via a log analytics component, log data from the insights component; and transmitting, via user interface, the response.

An embodiment of the present invention is directed to an innovative middleware layer that supports many different types of LLMs. The middleware layer may be represented as a Digital Matrix that provides a plug-in approach that interfaces with various AI models, LLMs, etc. An embodiment of the present invention may manage load across various backend systems in a consistent and efficient manner. In addition, data sets may be accessed and leveraged in a safe and useful way where data is protected and secured. The middleware layer provides the ability to combine responses from multiple models and generate unique enhanced responses to specific requests that current systems are unable to support or provide.

An embodiment of the present invention is directed to an innovative generative AI platform that supports various generative AI (“Gen AI”) services. Autonomous features may involve: combining separate and distinct LLM responses and prompts to create unique results; scaling and auto deployment of models and rerouting requests autonomously to ensure user load is balanced across an entire globally distributed Gen AI infrastructure estate. In addition, the innovative AI platform provides an ability to combine concurrent prompt responses from multiple LLMs with proprietary and even sensitive data to create new responses, outputs and ideas. The innovative AI platform provides auditing features and support for subscriptions. An embodiment of the present invention provides an innovative Digital Matrix Middleware Solution to address the current difficulties in onboarding new models as technological advances at a rapid pace.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary architecture, according to an embodiment of the present invention.

FIG. 2 is an exemplary high level diagram, according to an embodiment of the present invention.

FIG. 3 is an exemplary services diagram, according to an embodiment of the present invention.

FIG. 4 is an exemplary cognitive search process diagram, according to an embodiment of the present invention.

FIG. 5 is an exemplary user interface, according to an embodiment of the present invention.

FIG. 6 is an exemplary flow diagram, according to an embodiment of the present invention.

FIG. 7 is an exemplary flow diagram, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to an innovative generative AI service based on proprietary expertise and industry knowledge. The generative AI service provides autonomous features, such as combining separate and distinct LLM responses and prompts to create unique results. Current solutions offer access to a single LLM at a time which produces limited results. Other autonomous features may include: ability to handle scaling and auto deployment of models and rerouting requests autonomously to ensure user load is balanced across the entire globally distributed Generative AI infrastructure estate. The generative AI service may further deploy new production instances of models on demand if required/desired by predefined system criteria as well as by explicit user requests based on projected demand increase and/or the need for a specific instance for further model fine-tuning. The ability to provide new instances of models as needed is particularly useful for complex applications and unique requests in a manner that makes efficient use of technical resources and compute power as AI models require significant resources.

The generative AI service provides an ability to combine concurrent prompt responses from multiple LLMs with proprietary data to create new “responses” or ideas. Current solutions generally rely on a single LLM at a time which provides good but limited results. By combining results from multiple LLMS through an innovative middleware platform, an embodiment of the present invention is able to create results for complex requests in an optimized and efficient manner. The ability to optimize model selection is unavailable with current solutions that are unable to support multiple LLMs in an efficient and technologically streamlined manner to provide meaningful results.

An embodiment of the present invention enables the system to be auditable and traceable with integrated responsibility capabilities and data provenance that may be globally and centrally managed to create a consistent approach to model usage and observability.

In addition, the generative AI service may provide support for subscriptions for client access. This may involve offering different tiers of service for models and throughput and further enabling clients with different budgets and/or needs to access the system at varying levels.

The functionality, process, and code required to enable the above capabilities may be combined into a series of service that forms an overall platform.

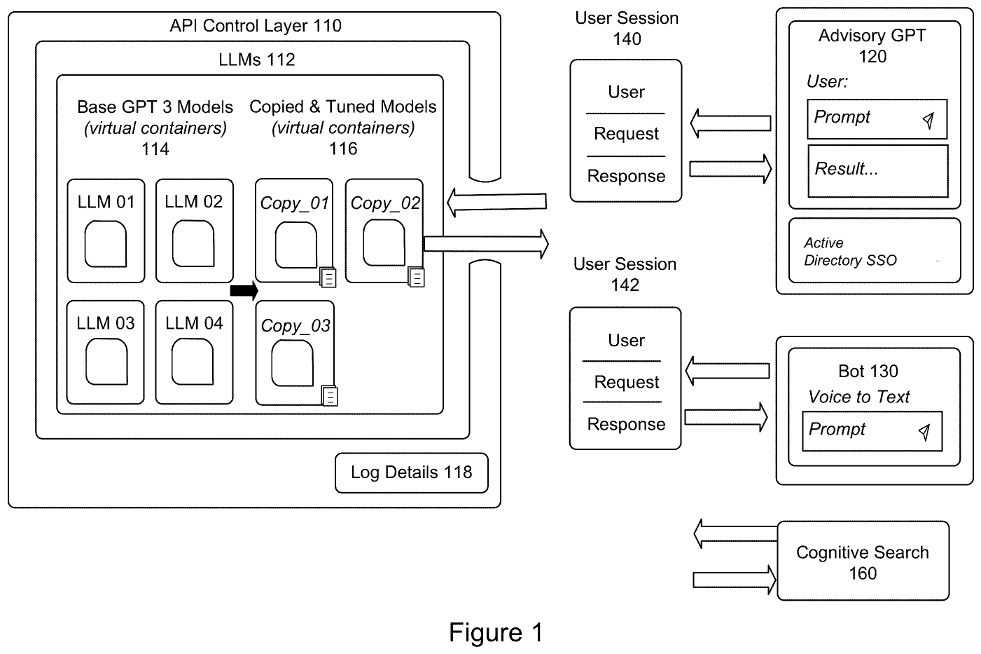

FIG. 1 is an exemplary architecture, according to an embodiment of the present invention. As shown in FIG. 1, API Control Layer 110 may include various large language models (LLMs) 112. An embodiment of the present invention recognizes that each LLM is unique with endless variations. While an embodiment of the present invention illustrates particular LLMs as examples, other LLMs, models and variations may be supported. LLM 01 may represent a large and most capable language model, such as DaVinci, that can solve logic problems, determine cause and effect, understand intent, produce creative content, and handle complex summarization tasks. LLM 02 may provide a balance of power and speed and also handle complex classifications tasks and nuanced tasks, e.g., sentiment analysis, chatbot applications, etc. An example of LLM 02 may include Curie. LLM 03 may represent a next most capable engine, such as Babbage. Finally, LLM 04 may represent a fast and low-cost engine, such as Ada. FIG. 1 is illustrative only and may support various other LLMs and models.

ChatGPT and other models may be available via a service, such as Microsoft Azure OpenAI Service. Models may exist in a virtual container with no connection to data sources (e.g., only prompts). As shown in FIG. 1, Virtual Containers 114 may represent an isolated virtual environment where models may be run independently and securely in a self-contained unit. Models may be copied and tuned to emphasize or de-emphasize existing memories, as shown by 116. Through the training process, a copy of a model may be created that responds in a certain way. Models may remain unchanged through user interactions. In this exemplary illustration, new memories are not added to a copied/tuned model. Other variations in tuning models may be supported.

Users may interact through various user interfaces, such as an Advisory GPT 120, Bot 130, Cognitive Search 160, etc. Each UI may have a separate user session that captures User, Request and Response, as shown by 140, 142. For example, user interaction may be through voice where Bot 130 provides a voice to text capability. The text may be formatted, as shown by User Session 142, for interaction with LLMs 112.

As shown in FIG. 1, an embodiment of the present invention may provide a different user experience for each app, such as Advisory GPT 120, Bot 130, Cognitive Search 160, etc. Each app or applet may perform specific functions and provide a set of features while accessing an appropriate subset of data. Other interfaces and variations may be supported.

For example, Open AI GPT may send a prompt, receive a response and then present the response to user. On the backend, an embodiment of the present invention may capture cost information and also log data from a governance, compliance and/or billing perspective. FIG. 1 illustrates Log Details 118. While a single component is shown, an embodiment of the present invention may maintain multiple log files, e.g., a different log file for each app. In addition, different controls may be in place for each app.

Within a client framework, client-specific apps may connect to models, via a user interface. Authenticated users may enter requests and receive responses. In addition, user actions may be logged for analytics and insights as well as to manage access, control, compliance, etc. Logging provides transparency in user requests and query costs and further supports and facilitates billing, governance and compliance.

An embodiment of the present invention is directed to an Advisory GPT that represents a personal assistant to support various tasks and requests from users. This enables users to engage in human like conversations and interactions. Advisory GPT may be hosted on a secure cloud instance to support client and proprietary data to craft user prompts. Various functions may include: brainstorming ideas; learning new concepts; drafting emails; summarizing meeting notes; getting programming help; creating an executive summary; generate talking points for meetings, etc.

An embodiment of the present invention may support various use cases, including research and content creation. The system may be in the public domain, stand-alone system, integrated with existing systems, etc. This provides the ability to search and find information in a conversational form that produces easily digestible answers. Other variations may include embedding the innovative features in solutions. The system may be customized and built for a particular client, industry, scenario, etc. The system may also be embedded within delivery tools and other services. Other implementations and architectures may be supported.

Additional features may be implemented to improve efficiency and productivity. For example, knowledge management may use industry-specific knowledge, market intelligence, white papers and/or previous case studies as training data. This allows users, such as Advisory professionals, to retrieve related information. Content Curation may involve leveraging ChatGPT to aggregate and summarize the information gathered from a knowledgebase into concise, relevant, and actionable insights. Data-driven decision making may use ChatGPT to perform self-guided data analysis using client data.

Additional features may realize efficiencies through reduced costs. For example, process automation may integrate with internal applications to enhance live interactive guidance (e.g., helpdesk) or tutorials and may further allow software users to interface with applications using conversational UI (e.g., using written or spoken commands in plain language) rather than traditional UI controls. Automated Code Review and Testing may support: Solution Migration/Re-platform that converts current solution codes with a proprietary into new code base; ability to generate sample test data which mimics client data structure; ability to perform testing, error detection and debugging; as well as ability to generate documentation in technical and non-technical language formats to support the software.

Additional features may open up new opportunities for growth. For example, Proposal Generation may involve: asking ChatGPT to look at the last five Forensic proposals related to investigation and modify through the interface to meet the client needs; and review RFP requirements and identify missing sections and areas of improvements. Market and client insights may involve: using ChatGPT during market research to list and outline key research areas; provide potential data sources from both internal (previous researches and relevant engagements) and external sources; provide analysis and insights into market trends, client preferences, etc. Innovation and idea generation may involve reviewing a service offering list and areas of expertise and then comparing with industry trends to help identify and pursue new growth opportunities.

Additional features may enhance client satisfaction. For example, Project Management may involve integrating ChatGPT with Teams and generating meeting notes, summarizing action items, producing status report/progress updates, etc.

Engagement Feedback may use ChatGPT to develop an Engagement Bot which automates qualification write-up generation and management. For example, when an engagement ends, a Bot may analyze an engagement letter and proposal and then generate a qualification write-up which may be sent to a recipient, such as a partner or manager, for review and enhancement via a series of questions and/or other interactions. The qualification write-up provides a formal assessment and evaluation of qualifications, capabilities, and suitability for additional engagement in the technology, industry or other space. The workflow may then route responses to marketing for posting and/or other action and follow-up. Other write-ups and outputs may be supported.

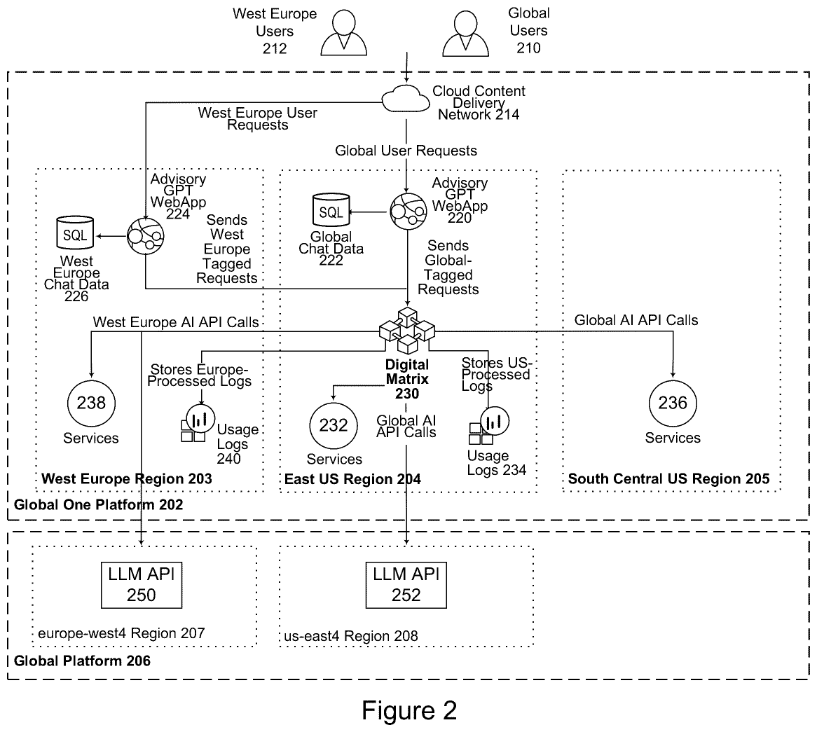

FIG. 2 is an exemplary high level diagram, according to an embodiment of the present invention. In this example, users may include users from various regions, such as West Europe Users 212 and Global Users 210. Users may interact with Digital Matrix 230 through Global One Platform 202 having multiple regions as shown by 203, 204, 205. Digital Matrix 230 may interact with LLM APIs, as shown by 250, 252, in corresponding regions, as shown by 207, 208, through Global Platform 206.

A Cloud Content Delivery Network 214, e.g., Azure Front Door, receives requests which may be specific to a region, e.g., West Europe Region 203, East US Region 204, South Central US Region 205, etc. As shown in FIG. 2, West-Europe user requests may be sent to an Advisory GPT WebApp 224 with access to region specific data, e.g., West Europe Chat Data 226. Global user requests may be sent to a corresponding Advisory GPT Web App 220 with access to Global Chat Data 222.

Respective tagged requests may be sent to Digital Matrix 230. Digital Matrix 230 may then send API calls to one or more appropriate AI services, such as 238, 232, 236. In addition, corresponding Usage Logs 240, 234, may be stored and processed.

Digital Matrix 230 may uniquely interact with services in the US, regionally and globally. With an embodiment of the present invention, multiple instances may run on different environments. An embodiment of the present invention may combine with proprietary data and knowledge. This enables the system to search priority data and generate responses that would not be available to the public.

An exemplary use case may involve combining multiple responses from a plurality of LLMs into a single data block which may then be fed into another model to summarize the combined results. For example, a fine-tune model may be applied to summarize responses from multiple LLMs into a comprehensive response.

According to an embodiment of the present invention, Digital Matrix 230 may support a plug-in approach that interfaces with many different types of AI models, LLMs, etc. An array of third party plug-ins may add functionality to multiple Gen AI models. Additionally, internal plug-ins may be connected to internal, external and other applications. Digital Matrix 230 may be used to manage: external connections to any plug-ins; connection of a plug-in to one or more models; cost and usage monitoring of plug-ins as well as any data restrictions resulting form differing levels of trust to the plug-ins.

An embodiment of the present invention may support various architectures and implementations, including an embedded system as well as access through an API and/or other interface to enable customers and other end users to access.

An embodiment of the present invention supports iterative tasks and queries. Because the system has access to various LLMs and/or services, each iteration may connect to a separate service which may work in parallel or in a collaborative manner to address the task, query and/or other request.

An embodiment of the present invention also supports an ability to selectively engage with various back-end LLMs, services, data, knowledgebase, etc. This may further support a monetization scheme as well as tiered access/security feature.

An embodiment of the present invention recognizes that each language model is uniquely different. Accordingly, there are various ways to optimize usage in terms of cost, efficiency, speed, etc. This may involve implementing an optimized model selection process. For example, when speed is not an issue, a less expensive model may be implemented. Other considerations may involve load balancing, high usage/volume, specific use/application, speed, etc.

An embodiment of the present invention is directed to securely monitoring data for LLMs or other models and then storing the monitored data in a central log. This enables the system to generate insights, such as who are the users, how are they using the data, etc.

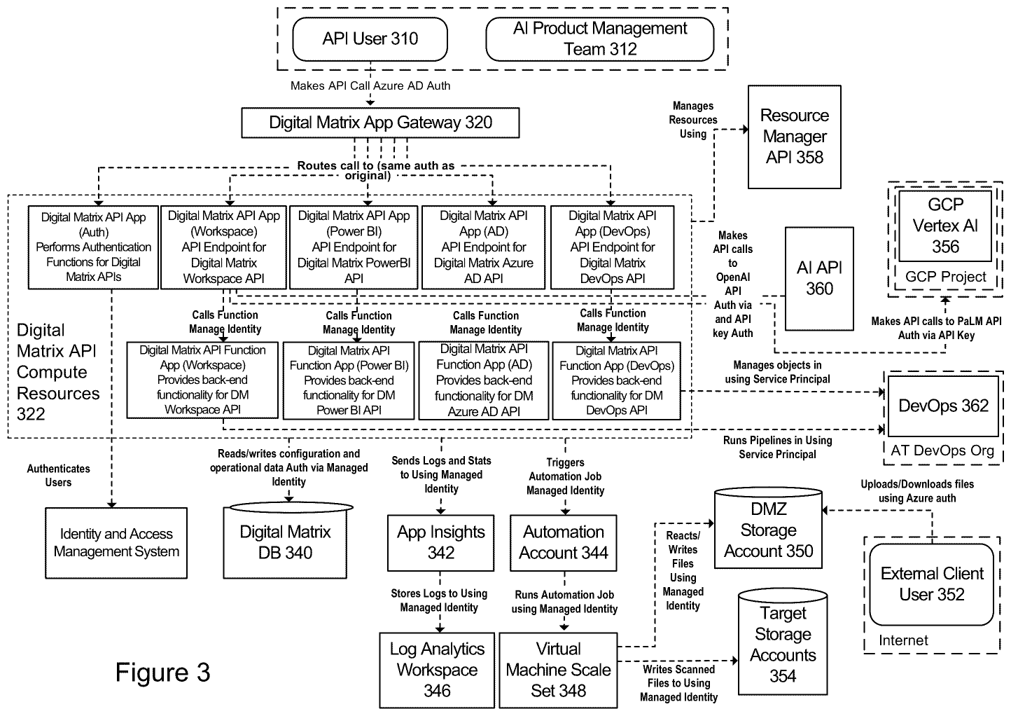

FIG. 3 is an exemplary services diagram, according to an embodiment of the present invention. Users may represent API User 310, AI Product Management Team 312 members, etc. API User 310 may represent a teammate or user who has been granted access to middleware platform Digital Matrix. A product management team member, such as 312, may represent an AI product stakeholder who has access to AI usage reports.

API User 310 may make API calls to Digital Matrix App Gateway 320, which routes Digital Matrix API requests to App Services. Digital Matrix App Gateway 320 may then route calls to Digital Matrix API Compute Resources 322 which may include Digital Matrix API Apps and Digital Matrix API Function Apps.

Digital Matrix API apps may provide various features, such as authentication functions for digital matrix APIs; API endpoint for digital matrix workspace API; API endpoint for digital matrix PowerBI API; API endpoint for digital matrix Azure AD API; API endpoint for digital matrix DevOps API, etc.

Digital Matrix API Function Apps may provide various features, such as back-end functionality for DM workspace API; back-end functionality for DM PowerBI API; back-end functionality for DM Azure AD API; back-end functionality for DM DevOps API, etc.

Digital Matrix API Compute Resources 322 may support read/write configurations and operational data Authentication via Managed Identity, as shown by Digital Matrix DB 340 which stores configuration data.

Digital Matrix API Compute Resources 322 may send logs and statistics to App Insights 342 using Managed Identity. App Insights 342 may receive application telemetry (e.g., logs, metrics, events, traces, etc.) from Digital Matrix apps and functions. For example, logs may be stored using Managed Identity to Log Analytics Workspace 346.

Digital Matrix API Compute Resources 322 may trigger an automation job using managed identity as shown by Automation Account 344, which runs virus scans and file movement jobs. Automation Job may run using Managed Identity, as shown by Virtual Machine Scale Set 348, e.g., VMSS/ADO Agent for performing virus scanning. Virtual Machine Scale Set 348 may read/write files to DMZ Storage Account 350 which may include an edge/internet facing storage account for file transfer. External Client User 352 may upload/download files. External Client User 352 may represent an external user with access to upload/download from a specific DMZ storage container. Scanned Files may be stored in Target Storage Accounts 354.

GCP Vertex AI 356 may represent a platform that provides a unified environment for building, deploying and scaling AI and machine learning models. For example, Digital Matrix API App may make API calls to PaLM API to GCP Vertex AI. Other LLM or AI models may be implemented.

Resource Manager API 358 may represent a service for provisioning and managing resources. AI API 360 may represent a service for interacting with OpenAI or other AI platform or service. DevOps 362 may represent a platform that brings together developers, project managers and contributors to develop software.

API consumers may call APIs using service principal or service account to Digital Matrix App Gateway 320. API Consumers may interact with applications that utilize Digital Matrix APIs to communicate, send emails and/or other supported functions. For example, a web-based user interface may call Digital Matrix API using a service principal. The web-based user interface provides a graphical experience to interact with Digital Matrix cloud based application programmable interfaces without having to write code to do so. In this example, the web-based user interface may support web applications for leveraging Digital Matrix APIs to self-service provision virtual machines (VMs) in production.

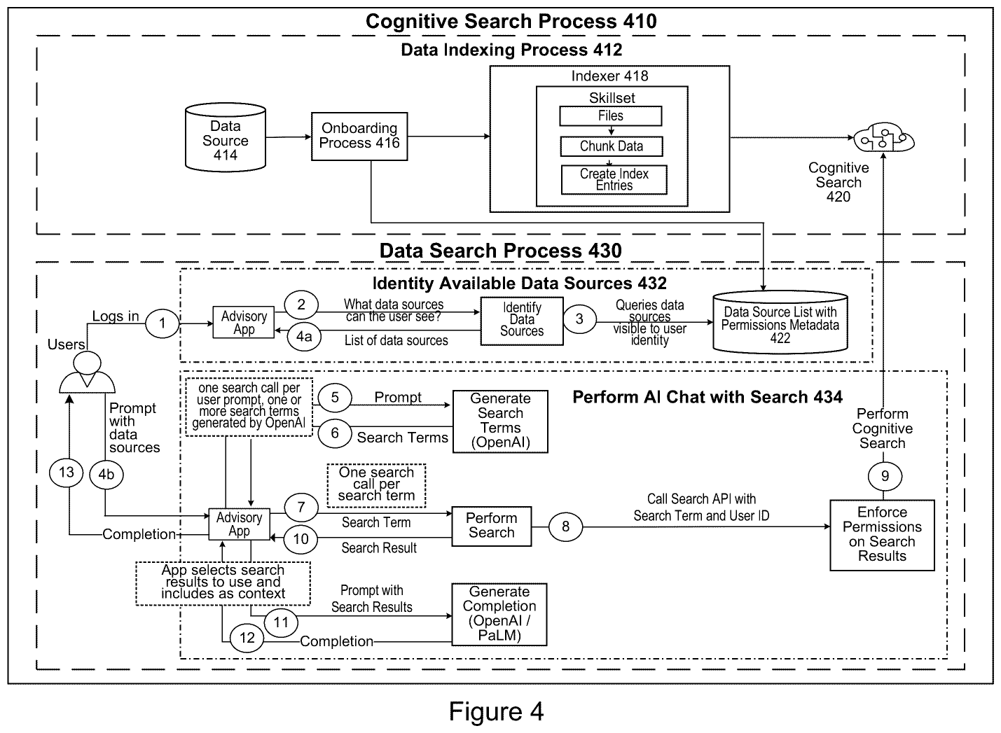

FIG. 4 is an exemplary cognitive search process diagram, according to an embodiment of the present invention.

As shown in FIG. 4, Cognitive Search Process 410 may include a Data Indexing Process 412 and Data Search Process 430 which includes Identify Available Data Sources 432 and Perform AI Chat with Search 434. Data Source 414 may include metadata such as user permissions, business friendly data, document path, creation/modified timestamp, owner, etc. Onboarding Process 416 may include identifying subsections of a data source that may be indexed and added to an indexer. Indexer 418 may include skillset which includes files (e.g., crack files), chunk data, create index entries, etc. Indexer 418 supports Cognitive Search features represented by 420.

As shown by FIG. 4, Users may login (step 1) and interact with an Advisory App that may identify data sources to be queried (step 2). Data sources that are visible to a user identity may be queried (step 3) from Data Source List with Permission Metadata 422. A list of data sources may be provided (step 4a).

The data sources may be accessed to generate a prompt and search terms (steps 4b, 5, 6).

Search terms may be applied to perform a search (step 7) which may involve calling Search API with search terms and user ID (step 8). Permissions may be enforced on search results, (steps 9, 10).

The Advisory App may select results to use and include as context (steps 11, 12).

As shown in FIG. 4, an embodiment of the present invention may coordinate and leverage central services and provide cognitive search content back from services, which may be combined and made available to a requesting user.

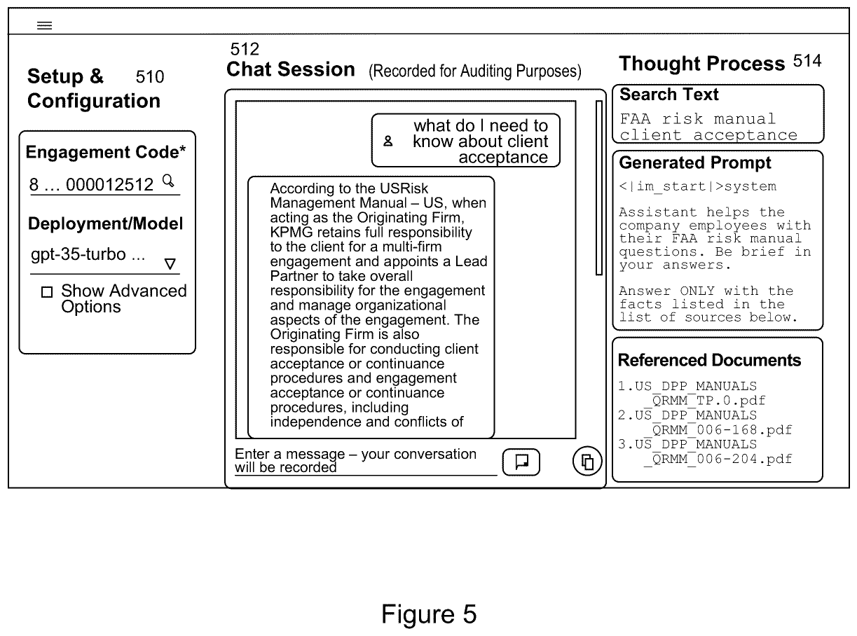

FIG. 5 is an exemplary user interface, according to an embodiment of the present invention. FIG. 5 illustrates an interface for cognitive search, according to an embodiment of the present invention.

FIG. 5 illustrates Setup & Configuration 510; Chat Session 512 and Thought Process 514. Thought Process 514 provides additional insights and processing data from multiple models. In this example, Thought Process 514 insights may include: Search Text; Generated Prompt; and Referenced Documents.

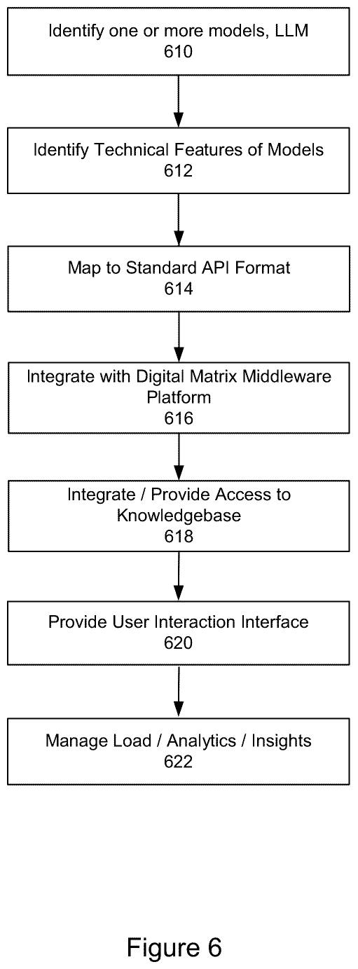

FIG. 6 is an exemplary flow diagram, according to an embodiment of the present invention. FIG. 6 illustrates a process that identifies a new model to integrate with the Digital Matrix Middleware Platform. At step 610, one or more models, such as LLMs, may be identified. At step 612, technical features of the models may be ascertained. This may include vendor specific details, such as how the model works, type of data, response, pricing, etc. At step 614, the model may be mapped to a standard API format for consistency. At step 616, the model may be integrated with the Digital Matrix Middleware Platform. This may occur via a plug-in approach. At step 618, the model may access various sources of data, including proprietary knowledgebases, etc. At step 620, user interaction with the model may be provided through an interface, bot, search, etc. At step 622, load balancing may be managed and applied. In addition, analytics, insights and/or other data may be managed and analyzed. While the process of FIG. 6 illustrates certain steps performed in a particular order, it should be understood that the embodiments of the present invention may be practiced by adding one or more steps to the processes, omitting steps within the processes and/or altering the order in which one or more steps are performed.

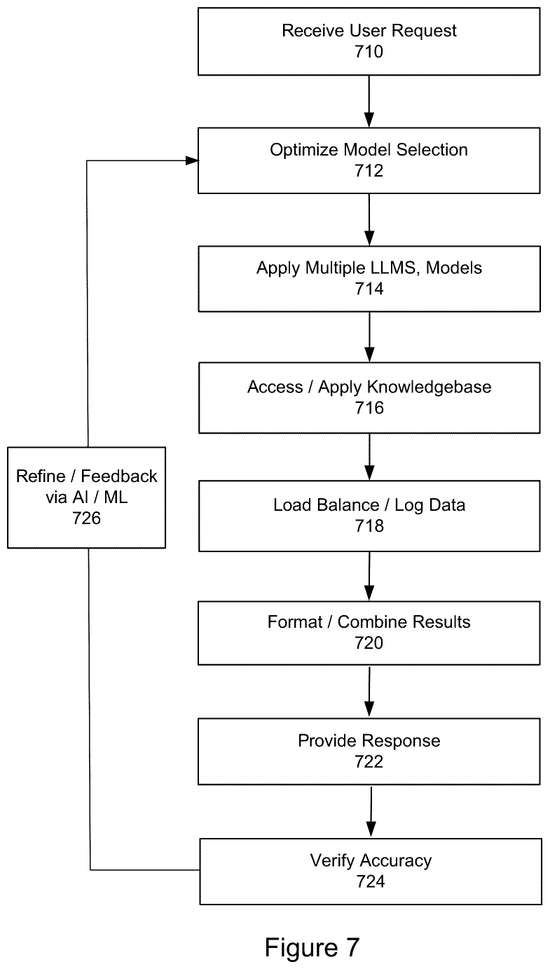

FIG. 7 is an exemplary flow diagram, according to an embodiment of the present invention. FIG. 7 illustrates user interactions with the Digital Matrix Middleware Platform. At step 710, a user request may be received through an interface or other input. At step 712, model selection may be optimized. Optimization may consider various factors, including speed, use case, response type, cost, complexity, etc. Model selection may involve a single model, multiple models or even all available models, at step 714. At step 716, various types of data may be integrated, such as proprietary knowledgebases. At step 718, load balancing may be applied and log data may be gathered. At step 720, a response to the user request may be generated. The response may include results from multiple models, LLMs, AI services, etc. The response may be formatted and provided in response to the user request, at step 722. The accuracy of the response may be verified at step 724. Model selection may be further optimized through a refinement/feedback process at step 726. The refinement may be enhanced through AI/ML for improved accuracy or other performance metric including cost, speed, compute power, etc. While the process of FIG. 7 illustrates certain steps performed in a particular order, it should be understood that the embodiments of the present invention may be practiced by adding one or more steps to the processes, omitting steps within the processes and/or altering the order in which one or more steps are performed.

Users may communicate with Digital Matrix via various networks. For example, the Digital Matrix may communicate and integrate with other devices and support various configurations and architectures. Digital Matrix may support interactions on devices including mobile or computing device, such as a laptop computer, a personal digital assistant, a smartphone, a smartwatch, smart glasses, other wearables or other computing devices capable of sending or receiving network signals. Digital Matrix may include computer components such as computer processors, microprocessors and interfaces to support applications including browsers, mobile interfaces, dashboards, interactive interfaces, etc. Other functions and features represented may be supported in various forms and implementations. While the Figures illustrate individual devices or components, it should be appreciated that there may be several of such devices to carry out the various exemplary embodiments.

Digital Matrix may be communicatively coupled to various data sources including any suitable data structure to maintain the information and allow access and retrieval of the information. Data Sources may be local, remote, cloud or network based. Communications with Data Sources may be over a network, or communications may involve a direct connection.

Networks may be a wireless network, a wired network or any combination of wireless network and wired network. Networks may comprise a plurality of interconnected networks, such as, for example, a service provider network, the Internet, a cellular network, corporate networks, or even home networks, or any of the types of networks mentioned above. Data may be transmitted and received via a Network utilizing a standard networking protocol or a standard telecommunications protocol.

The system of an embodiment of the present invention may be implemented in a variety of ways. Architecture within the system may be implemented as hardware components (e.g., module) within one or more network elements. It should also be appreciated that architecture within the system may be implemented in computer executable software (e.g., on a tangible, non-transitory computer-readable medium) located within one or more network elements. Module functionality of architecture within the system may be located on a single device or distributed across a plurality of devices including one or more centralized servers and one or more mobile units or end user devices. The architecture depicted in the system is meant to be exemplary and non-limiting. For example, while connections and relationships between the elements of the system are depicted, it should be appreciated that other connections and relationships are possible. The system described below may be used to implement the various methods herein, by way of example. Various elements of the system may be referenced in explaining the exemplary methods described herein.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the System software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

What is claimed is:

1. A computer-implemented system for implementing a middleware platform that provides a series of generative AI services, the system comprising:
a user interface that is configured to receive one or more requests from a user, via a communication network;
a Digital Matrix Application Gateway that is configured to receive the one or more requests and route the one or more requests to a set of API Compute Resources, wherein the set of API Compute Resources comprises one or more API Apps and one or more API App Functions, wherein each of the set of API Compute Resources is configured to make calls to one of a plurality of APIs, wherein the set of API Compute Resources interacts with a plurality of different large language models (LLMs) that collectively generate a response to the one or more requests;
a data storage component that reads and writes configuration and operational data associated with the API Compute Resources;
an insights analytics processing component that is configured to receive application telemetry data from one or more API Compute Resources; and
a log analytics component that stores log data from the insights component.

2. The system of claim 1, wherein the response represents a combination of LLM responses from the plurality of LLMs.

3. The system of claim 1, wherein the plurality of LLMs have access to a proprietary knowledgebase.

4. The system of claim 1, wherein user load balancing is applied across the plurality of different LLMs on an entire globally distributed generative AI infrastructure.

5. The system of claim 1, wherein the user interface comprises a generative AI chat interface.

6. The system of claim 1, wherein the user interface comprises a cognitive search interface.

7. The system of claim 1, wherein each of the plurality of LLMs is independently run and secured in a virtual container.

8. The system of claim 1, wherein a copy of a LLM from the plurality of LLMs is created to respond in a predetermined way through a training process to create a tuned version of the LLM.

9. The system of claim 1, wherein the log data is globally and centrally managed to determine model usage and performance metrics across the plurality of different LLMs.

10. The system of claim 1, wherein the plurality of LLMs are selected based on model optimization.

11. A computer-implemented method for implementing a middleware platform that provides a series of generative AI services, the method comprising the steps of:
receiving, via a user interface, one or more requests from a user, via a communication network;
receiving, via a Digital Matrix Application Gateway, the one or more requests and routing the one or more requests to a set of API Compute Resources, wherein the set of API Compute Resources comprises one or more API Apps and one or more API App Functions, wherein each of the set of API Compute Resources is configured to make calls to one of a plurality of APIs, wherein the set of API Compute Resources interacts with a plurality of different large language models (LLMs) that collectively generate a response to the one or more requests;
reading and writing, via a data storage component, configuration and operational data associated with the API Compute Resources;
receiving, via an insights analytics processing component, application telemetry data from one or more API Compute Resources;
storing, via a log analytics component, log data from the insights component; and
transmitting, via user interface, the response.

12. The method of claim 11, wherein the response represents a combination of LLM responses from the plurality of LLMs.

13. The method of claim 11, wherein the plurality of LLMs have access to a proprietary knowledgebase.

14. The method of claim 11, wherein user load balancing is applied across the plurality of different LLMs on an entire globally distributed generative AI infrastructure.

15. The method of claim 11, wherein the user interface comprises a generative AI chat interface.

16. The method of claim 11, wherein the user interface comprises a cognitive search interface.

17. The method of claim 11, wherein each of the plurality of LLMs is independently run and secured in a virtual container.

18. The method of claim 11, wherein a copy of a LLM from the plurality of LLMs is created to respond in a predetermined way through a training process to create a tuned version of the LLM.

19. The method of claim 11, wherein the log data is globally and centrally managed to determine model usage and performance metrics across the plurality of different LLMs.

20. The method of claim 11, wherein the plurality of LLMs are selected based on model optimization.
